(19) United States
(12) Patent Application Publication
(10) Pub. No.: US 2021/0189093 A1
(43) Pub. Date: Jun. 24, 2021

(54) GARDEN BACTERIA FOR COMPOSTING PLASTICS

(71) Applicant: Catherine E. Wood, Manhattan Beach, CA (US)

(72) Inventor: Catherine E. Wood, Manhattan Beach, CA (US)

(21) Appl. No.: 17/190,826

(22) Filed: Mar. 3, 2021

(51) Int. Cl. C08J 11/28

(52) U.S. Cl. CPC C08J 11/28; C08J 2375/04

(57) ABSTRACT

Plastic human waste is a growing threat to today's environment. A simple and viable method of reducing the mass of waste in landfills is using microbial organisms to decompose plastics that would otherwise add to the accumulation of garbage. Presented here is the discovery of a new microorganism having the ability to degrade polyurethane plastics. Methods for composting polyurethane using this microorganism may help reduce amounts of human trash.

### TECHNICAL FIELD

The field of this invention is composting.

### BACKGROUND OF THE INVENTION

As the use of plastics like polyurethanes have increased throughout the world, a problem has arisen in how to properly dispose of the trash formed from these materials. Currently, there are two major methods of keeping these materials out of landfills: recycling and incineration. While recycling is good, because the growth in the use of the plastics is greater than the growth of recycling technologies, other methods are needed.

In considering environmentally clean methods for the decomposition of plastics, the current options of recycling and incineration force a choice between effectiveness and environmental friendliness. But another option is available: bioremediation, which is the use of naturally occurring microorganisms to break down human waste. This option balances ecologically friendly techniques with costs and efficiency.

Bioremediation relies on biological processes to break down human pollutants such as plastic bags and bottles, many of which are made from polyurethane materials. However, one problem that occurs in the process of bioremediation is finding ideal organisms to consume the plastic waste. Ideal microorganisms for this are those that are present in the local environment where the plastics will be degraded. Locally sourced microorganisms like those already present in soils and decomposing organic matter are ideal because they are best suited to compost in that environment and also do not risk possible problems from the introduction of potentially invasive non-native microbes into new environments.

### SUMMARY OF THE INVENTION

In order to identify microorganisms that can break down polyurethane materials, I took microorganisms found in composting organic matter from a garden in Southern California and tested them for their ability to degrade polyurethane. These tests identified a previously undescribed species of bacteria within the Bordetella genus. This microorganism can be used to compost polyurethane plastic waste.

The new Bordetella bacteria is useful for composting polyurethane trash. This can be done by combining polyurethane trash with the Bordetella bacteria species described here and compostable organic matter such as leaves, stems, roots, fruits, seeds etc. In one specific example, compostable matter is mixed with polyurethane trash such as a polyurethane bag or bottle and this Bordetella bacteria that can utilize polyurethane as a carbon source. This compost combination is then mixed periodically and exposed to conditions suitable for microbial degradation of the combination of organic matter and polyurethane. While a variety of composting systems can use these microorganisms, this bacteria was observed to grow well and degrade polyurethane within a rotatable composting container that was rotated at least once a week.

A commercial embodiment of the invention is a polyurethane composting kit that contains a seed culture of live polyurethane degrading organism(s). The composting kit can, for example, include a handful of leaves or other composting material that have been coated with the Bordetella bacteria, along with instructions on how to use this microorganism to compost with polyurethane. These polyurethane compositing kits can be sold online, and at gardening stores and nurseries.

### BRIEF DESCRIPTION OF THE DRAWINGS

FIGS. 1A and 1B provide schematic drawings showing how polyurethane degrading microorganisms change liquid polyurethane only medium from its initial opaque appearance (1A) to clear (1B).

FIGS. 2A and 2B provide shows how polyurethane degrading microorganisms change a zone of petri dish medium from its initial opaque appearance (2A) to clear (2B).

FIG. 3 provides the results of a Charles Rivers Laboratories Accugenix database search on a DNA sequence obtained from the polyurethane degrading microorganism isolated from our garden (designated “C2039593” in this Figure). Comparisons of this DNA sequence with known DNA sequences from a library of bacterial DNA sequences identified the polyurethane degrading microorganism isolated from our garden as coming from a bacteria in the Bordetella genus. This Figure shows the percentage of relatedness of the DNA sequences from related microorganisms, and a neighbor joining tree showing the relatedness of these microorganisms.

### DETAILED DESCRIPTION OF THE INVENTION

Polyester polyurethane is a plastic widely used in industry and manufacturing that has been shown to be susceptible to biodegradation. The invention involves harnessing the power of microorganisms to degrade polyurethane trash, such as disposable polyurethane bottles or bags

As discussed below, a number of organisms growing on sheets of synthetic polymer polyester polyurethane that had been mixed with composting plant matter from our garden in Southern California were tested for their ability to degrade polyurethane in both solid and liquid cultures. These tests resulted in the identification of a new bacterial species.

The strategy used to isolate these organisms was adapted from Russell et al., APPLIED AND ENVIRONMENTAL MICROBIOLOGY, September 2011, p. 6076-6084, which examined microorganisms collected in the Yasuni National Forest in the Ecuadorian Amazonian rainforest. Initially, sheets of polyurethane plastic were mixed with garden plant matter and soil from a garden in Southern California and composted in a rotatable composter for six weeks, with the compost being mixed at least once a week. After six weeks, organisms found growing on these polyurethane sheets were screened for their ability to degrade polyurethane using a microbial growth media that included polyurethane as a sole carbon source.

The media used to isolate the microorganisms was prepared by the microbial media company TEKNOVA following the media recipes found in Russell et al., APPLIED AND ENVIRONMENTAL MICROBIOLOGY, September 2011, p. 6076-6084. This custom media used Impranil DLN as a food/carbon source for the microorganisms. Impranil DLN is a polyester polyurethane that forms an opaque milky suspension that becomes transparent upon degradation. If an organism grows in the Impranil DLN media, this means that it can use polyurethane as the sole carbon source for metabolism and growth. Organisms capable of degrading this polymer display a zone of clearance around the growing culture. Using this polyurethane media, organisms from the compost were screened for their ability to degrade polyurethane in both liquid (flask) and solid (petri dish) cultures.

Microorganisms were assayed for their ability to degrade polyurethane by combining liquid polyurethane media with a small piece of a polyurethane sheet taken from the compost mix and growing the organisms present on this sheet in this liquid polyurethane media. Other test samples were dabbed from a polyurethane sheet onto and grown on solid medium in petri dishes. The custom media contained 19 mM NaH2PO4, 33.5 mM K2HPO4, 7.6 mM (NH4)2504, 2.5 mM Na citrate, 250 μM MgSO4, 19 μM thiamine, 147 μM FeCl3-6H2O, 14 μM ZnCl2-4H2O, 12 μM CoCl2-6H2O, 12 μM Na2MoO4-2H2O, 10 μM CaCl2-2H2O, 11 μM CuCl2, 12 μM MnCl2, 12 μM H3BO3, and 1.8 mM HCl. To 1 liter of this mixture was added 10 ml Impranil DLN. For solid assays, 15 g/L of agar was added to this medium.

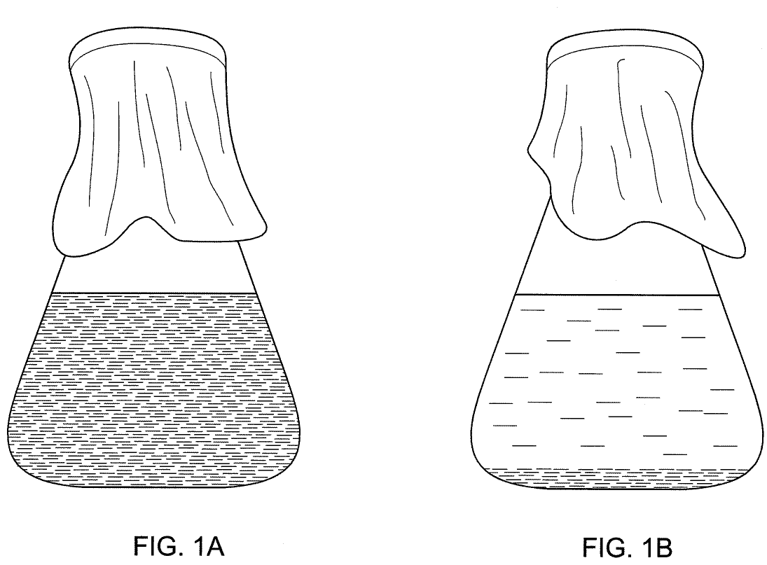

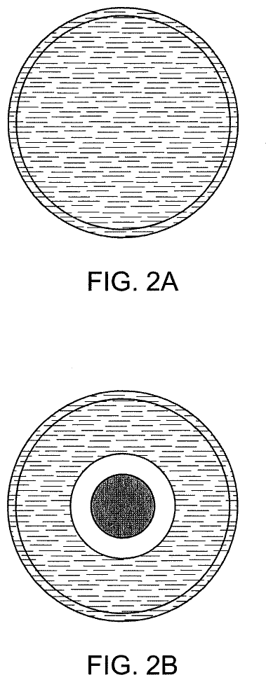

FIG. 1 diagrams how polyurethane degrading microorganisms changed the liquid polyurethane medium from its initial opaque appearance (FIG. 1A) to a translucent one (FIG. 1B). For the solid medium screening assay polyurethane solid medium was blotted with composted polyurethane sheets and then grown at 37 C for 1 week. Polyurethane degradation was evidenced by a change in the petri dish medium appearance from opaque to a translucent one. FIG. 2 diagrams how polyurethane degrading microorganisms changed the petri dish medium from its initial opaque appearance (FIG. 2A) to a translucent appearance (FIG. 2B). Organisms that have the ability to change the medium appearance in this way were isolated as pure cultures using a streak plate method. This isolation method involves the dilution of microorganisms by systematically streaking them over the exterior of the agar in a petri dish to obtain isolated colonies of identical microorganisms.

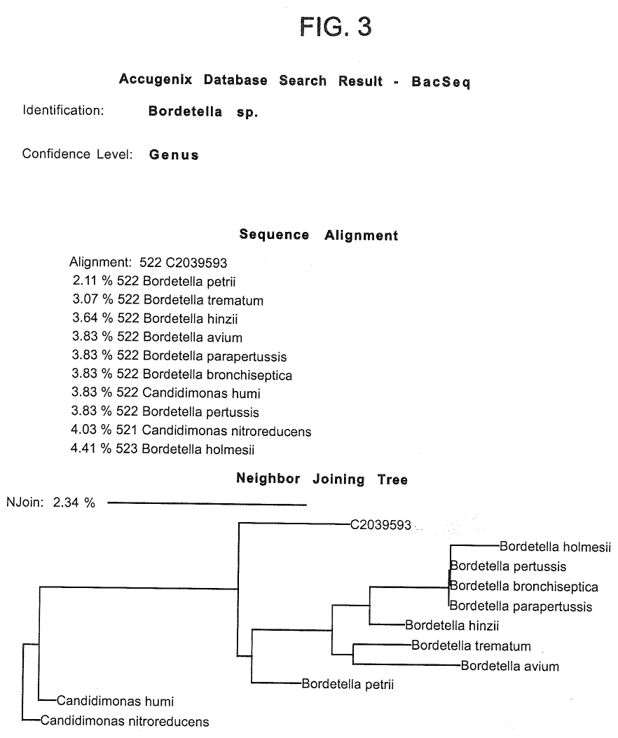

DNA sequencing of polyurethane degrading microorganisms that I isolated from the compost mix was then performed by Charles Rivers Laboratories using their AccuGENX-ID® system. This involves comparative DNA sequencing portions of the 16S rRNA gene in bacteria, DNA regions which are recognized as an accurate and reproducible marker for identifying unknown microorganisms. The DNA sequence information from the microorganism from the compost mix was then compared to DNA sequences in a library of known DNA sequences from different microorganisms. The results of this analysis are shown in FIG. 3. These tests identified a new Bordetella bacterial species having DNA sequence shown below.

A typical example of the invention is a kit that contains a seed culture of live polyurethane degrading organism(s) for use in composting. For example, a small composting kit (e.g. one weighing less than 10, 5, or 1 kilogram(s)) that includes a composition of matter comprising a Bordetella (identified as a Bordetella by having the DNA sequence found in the text below that is designated “SEQ ID NO: 1”). The composition in this kit can be designed to include some significant number of live organisms, for example at least 10,000 live microorganisms of the useful species.

### New Bacterial Species Within the Bordetella Genus

This microbe from the garden compost/polyurethane mix that was identified as being able to degrade polyurethane was designated test sample “522 C2039593” by Charles River Laboratories. Charles River Laboratories DNA sequencing tests show that it is a previously unknown species of bacteria within the Bordetella genus (see FIG. 3). This microorganism was identified by obtaining and sequencing its DNA, which showed that it includes the following DNA sequence:

(SEQ ID NO: 1)
TGGAGAGTTTGATCCTGGCTCAGATTGAACGCTAGCGGGATGCTTTACAC
ATGCAAGTCGAACGGCAGCGCGGACTTCGGTCTGGCGGCGAGTGGCGAAC
GGGTGAGTAATGTATCGGAACGTGCCCAGTAGCGGGGGATAACTACGCGA
AAGCGTGGCTAATACCGCATACGCCCTTATGGGGAAAGCGGGGGACCTTC
GGGCCTCGCACTATTGGAGCGGCCGATATCGGATTAGCTAGTTGGTGGGG
TAAAGGCTCACCAAGGCGACGATCCGTAGCTGGTTTGAGAGGACGACCAG
CCACACTGGGACTGAGACACGGCCCAGACTCCTACGGGAGGCAGCAGTGG
GGAATTTTGGACAATGGGGGCAACCCTGATCCAGCCATCCCGCGTGTGCG
ATGAAGGCCTTCGGGTTGTAAAGCACTTTTGGCAGGAAAGAAACGGCTCT
GGATAATACCTGGAGTCACTGACGGTACCTGCAGAATAAGCACCGGCTAA
CTACGTGCCAGCAGCCGCGGTA

In view of the manner in which it was isolated, the name “Bordetella plasticodestroyicus” is proposed for this new species of bacteria.

### Sequence Listing

The instant application contains a Sequence Listing which has been submitted electronically in ASCII format and is hereby incorporated by reference in its entirety. Said ASCII copy, created on Feb. 12, 2021, is named 275.2-US-01_SL.txt and is 981 bytes in size.

1. A method of composting comprising:
(a) combining together:
organic matter comprising at least one of: leaves, stems, roots; fruits or seeds;
a Bordetella species selected to:
comprise the DNA sequence of SEQ ID NO: 1; and
have an ability to utilize polyurethane as a sole carbon source; and
a polyurethane material;
(b) mixing the combination of (a);
(c) exposing the mixture of (b) to conditions suitable for microbial degradation of the combination of (a); such that the combination of (a) is composted.

2. The method of claim 1, wherein the polyurethane material is a polyurethane bag or a polyurethane bottle.

3. The method of claim 1, wherein the mixture is exposed to ambient environmental conditions for at least one month.

4. The method of claim 1, further comprising mixing the combination of (a) during compositing at least once a week.

5. A composting kit including a composition of matter comprising:
a Bordetella species selected to:
comprise the DNA sequence of SEQ ID NO: 1; and
utilize polyurethane as a sole carbon source;
a polyurethane.


SEQUENCE LISTING (1 sequence)

SEQ ID NO: 1 - DNA, 528 bp, Bordetella sp.
tggagagtttgatcctggctcagagtgaacgctggcggtaggcctaacacatgcaagtcgaacggcagcacagaggagcttgctccttgggtggcgagtggcggacgggtgaggaatacatcggaatctactctgtcgtgggggataacgtagggaaacttacgctaataccgcatacgacctacgggtgaaagcaggggaycttcgggccttgcgcgattgaatgagccgatgtcggattagctagttggcggggtaaaggcccaccaaggcgacgatccgtagctggtctgagaggatgatcagccacactggaactgagacacggtccagactcctacgggaggcagcagtggggaatattggacaatgggcgcaagcctgatccagccataccgcgtgggtgaagaaggccttcgggttgtaaagcccttttgttgggaaagaaatccagctggctaatacccggttgggatgacggtacccaaagaataagcaccggctaacttcgtgccagcagccgcggta